(19) United States
(12) Patent Application Publication
(10) Pub. No.: US 2023/0288944 A1
(43) Pub. Date: Sep. 14, 2023

(54) TRANSPORTATION SYSTEM, CONTROL METHOD, AND CONTROL DEVICE

(71) Applicant: NBC Corpotation, Minato-ku, Tokyo (JP)

(72) Inventors: Taichi Kumagai, Tokyo (JP); Hiroshi Yoshida, Tokyo (JP); Shinya Yasuda, Tokyo (JP)

(73) Assignee: NBC Corpotation, Minato-ku, Tokyo (JP)

(21) Appl. No.: 17/923,261

(22) PCT Filed: May 14, 2020
(86) PCT No.: PCT/JP2020/019244

§ 371 Date: Nov. 4, 2022

(51) Int. Cl. G05D 1/02; B66F 9/06

(52) U.S. Cl. CPC G05D 1/0297; B66F 9/063; G05D 1/0212; G05D 2201/0216

(57) ABSTRACT

Among a plurality of transportation systems manufactured by different manufacturers, when a collision avoidance function activates with respect to a transportation device belonging to a first transportation system and a transportation device belonging to a second transportation system, the transportation time becomes longer than initially expected and the transportation efficiency decreases. A transportation system includes a first transportation device used for work involving transportation of goods, and a control device. The control device is provided with: a prediction unit for predicting, based on progress information representing the progress of work, the state of travel of a second transportation device used for the work; a determining unit for determining a travel plan for the first transportation device according to the state of travel of the second transportation device predicted by the prediction unit; and a control unit for controlling the first transportation device based on the travel plan.

### TECHNICAL FIELD

The present invention relates to a transportation system, a control method, and a control device that control a transportation device.

### BACKGROUND ART

In work involving transportation of goods, such as production in a factory and logistics in a warehouse, a transportation device such as an automated guided vehicle (AGV) is widely used. Such a transportation device usually constitutes a transportation system, together with a control device that controls the transportation device. In this case, the transportation device transports goods according to a travel plan provided by the control device. As literatures which disclose such a transportation system, for example, PTLs 1 to 5 are cited.

### CITATION LIST

### Patent Literature

PTL 1] International Publication No. WO2019/123660
PTL 2] Japanese Unexamined Patent Application Publication No. 2018-147306
PTL 3] Japanese Unexamined Patent Application Publication No. 2005-352862
PTL 4] Japanese Unexamined Patent Application Publication No. H9-225783
PTL 5] Japanese Unexamined Patent Application Publication No. H6-102931

### SUMMARY OF INVENTION

### Technical Problem

In a factory, a warehouse, or the like, a plurality of transportation systems manufactured by different manufacturers may be introduced. Among transportation systems manufactured by different manufacturers, identity of an algorithm (also referred to as “a transportation policy”) in which a control device determines a travel plan for the transportation device is not guaranteed. Among a plurality of transportation systems manufactured by different manufacturers, a mechanism for sharing information such as a travel plan for the transportation device is not prepared either.

Therefore, between a transportation device belonging to a first transportation system and a transportation device belonging to a second transportation system, a situation in which transportation paths intersect with each other or current positions come to close to each other may easily occur. When the transportation device includes a collision avoidance function, collision of the transportation device is avoided even when such a situation occurs. However, when a collision avoidance function of the transportation device works, a transportation time is required more than initially supposed, and therefore, transportation efficiency is decreased. When, for example, two transportation devices stop based on mutual collision avoidance functions, a deadlock state is not resolved until a worker having rushed to a site completes recovery work, and therefore a significant delay may occur in production or logistics.

In view of the above-mentioned problem, one aspect of the present invention has been made, and an object thereof is to achieve a technique of controlling a transportation device in such a way that transportation efficiency is unlikely to decrease.

### Solution to Problem

A transportation system according to one aspect of the present invention includes: a first transportation device being used for work involving transportation of goods; and a control device, and the control device includes a prediction means for predicting, based on progress information representing a progress of the work, a travel status of a second transportation device being used for the work, a determining means for determining a travel plan for the first transportation device according to the travel status of the second transportation device, which is predicted by the prediction means, and a control means for controlling, based on the travel plan, the first transportation device.

A control method according to one aspect of the present invention includes, by a control device: predicting, based on progress information representing a progress of work involving transportation of goods, a travel status of a second transportation device being used for the work; determining, according to the travel status, a travel plan for a first transportation device being used for the work; and controlling, based on the travel plan, the first transportation device.

A control device according to one aspect of the present invention includes: a prediction unit that predicts, based on progress information representing a progress of work involving transportation of goods, a travel status of a second transportation device being used for the work; a determining unit that determines, according to the travel status, a travel plan for a first transportation device being used for the work; and a control unit that controls, based on the travel plan, the first transportation device.

### Advantageous Effects of Invention

According to one aspect of the present invention, it is possible to achieve a transportation system, a control method, and a control device that are capable of controlling a first transportation device in such a way that transportation efficiency is unlikely to decrease.

### BRIEF DESCRIPTION OF DRAWINGS

FIG. 1 is a plan view illustrating an outline of a factory in which a transportation system according to a first example embodiment of the present invention is introduced.

FIG. 2 is a diagram illustrating one example of management information used in the transportation system illustrated in FIG. 1.

FIG. 3 is a block diagram illustrating a configuration of the transportation system illustrated in FIG. 1.

FIG. 4 is a flowchart illustrating a control method in the transportation system illustrated in FIG. 1.

FIG. 5 is a data structure diagram illustrating one specific example of progress information illustrated in FIG. 1.

FIG. 6 is a flowchart illustrating a first specific example of a prediction step illustrated in FIG. 4.

FIG. 7 is a flowchart illustrating a second specific example of the prediction step illustrated in FIG. 4.

FIG. 8 is a block diagram of a computer operating as a control device in the transportation system illustrated in FIG. 1.

FIG. 9 is a block diagram illustrating a configuration of a control device according to a second example embodiment of the present invention.

### EXAMPLE EMBODIMENT

### First Example Embodiment

### Configuration of Transportation System

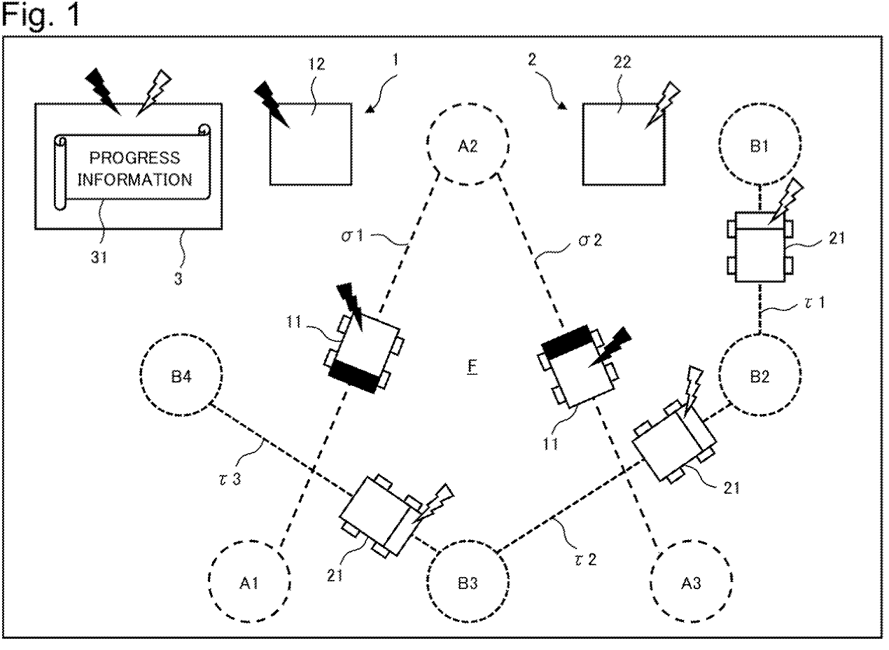

A configuration of a factory F in which a transportation system 1 according to a first example embodiment of the present invention is introduced is explained with reference to FIG. 1. FIG. 1 is a plan view illustrating an outline of the factory F.

In the factory F, the transportation system 1 and a transportation system 2 that play a role in transportation of goods and a production management device 3 (one example of “a management device” in the claims) that integrally manages production are introduced.

The transportation system 1 includes one or a plurality of transportation devices 11 (one example of “a first transportation device” in the claims) used for production in the factory F and a control device 12 (one example of “a control device” in the claims) that controls the transportation device 11. The transportation device 11 is configured in such a way as to be wirelessly communicable with the control device 12. The transportation device 11 transports, in accordance with a travel plan provided via wireless communication from the control device 12, goods such as a raw material, an intermediate product, and a product from a certain station to another station disposed in the factory F. According to the present example embodiment, as the transportation device 11, an automated guided vehicle (AGV), i.e., an unmanned transportation vehicle is used.

Herein, a travel plan is information indicating how the transportation device 11 needs to travel in order to transport goods. The travel plan includes, for example, information indicating a location where goods are picked up (e.g., a name of the location, a position thereof, and the like). The travel plan includes, for example, information indicating a start time or a termination time of travel. The travel plan includes, for example, information (a name of a path, one or a plurality of destinations, and a route order for a destination) indicating a transportation path where goods are transported. The travel plan includes, for example, information relating to a temporary stop (a location where a temporary stop is made, a stop period, and the like). The travel plan includes information relating to a change of a travel direction (a location in which or a time at which a travel direction is changed, a travel direction change content such as a circling angle, a right/left turn and straight advance, a destination after a travel direction change, and a period of travel by maintaining a travel direction after a change) and the like. The travel plan includes, for example, information indicating an attitude during travel, a velocity, and the like.

According to the present example embodiment, the transportation device 11 is used for transportation of goods from a station A1 to a station A2 and transportation of goods from the station A2 to a station A3. A transportation path σ1 from the station A1 to the station A2 and a transportation path σ2 from the station A2 to the station A3 may be a previously-determined transportation path or a transportation path autonomously determined by the transportation device 11. Hereinafter, an ith station to be used by the transportation device 11 is also described as a station Ai, and a transportation path connecting the station Ai to a station Ai+1 is also described as a transportation path σi.

The transportation system 2 includes one or a plurality of transportation devices 21 (one example of “a second transportation device” in the claims) used for production in the factory F and a control device 22 (one example of “another control device” in the claims) that controls the transportation devices 21. The transportation device 21 is configured in such a way as to be wirelessly communicable with the control device 22. The transportation device 21 transports, in an unmanned manner, in accordance with a travel plan provided via wireless communication from the control device 22, goods such as a raw material, an intermediate product and a product from a certain station to another station disposed in the factory F. According to the present example embodiment, as the transportation device 21, an AGV, i.e., an unmanned transportation vehicle is used.

According to the present example embodiment, the transportation device 21 is used for transportation of goods from a station B1 to a station B2, transportation of goods from the station B2 to a station B3, and transportation of goods from the station B3 to a station B4. A transportation path τ1 from the station B1 to the station B2, a transportation path τ2 from the station B2 to the station B3, and a transportation path τ3 from the station B3 to the station B4 may be a previously-determined transportation path or a transportation path autonomously determined by the transportation device 21. Hereinafter, an ith station to be used by the transportation device 21 is also described as a station Bi, and a transportation path connecting the station Bi to a station Bi+1 is also described as a transportation path τi.

The production management device 3 is configured in such a way as to be communicable, in a wireless or wired manner, with each of the control device 12 and the control device 22 and provides, for each of the control device 12 and the control device 22, via wireless communication or wired communication, progress information 31 indicating a progress status of production in the factory F. The control device 12 determines, based on the progress information 31 acquired from the production management device 3, a travel plan for the transportation device 11 included in the transportation system 1, in other words, the transportation device 11 under control of a local device (the control device 12). The control device 22 determines, based on the progress information 31 acquired from the production management device 3, a travel plan for the transportation device 21 included in the transportation system 2, in other words, the transportation device 21 under control of a local device (the control device 22). A specific example of the progress information 31 is described later, by replacing the drawing with a drawing to be referred to.

According to the present example embodiment, the transportation system 1 and the transportation system 2 are systems designed and manufactured by manufacturers different from each other. Therefore, sameness between an algorithm (also referred to as “a transportation policy” in some cases) for determining, by the control device 12, a travel plan for the transportation device 11 and an algorithm for determining, by the control device 22, a travel plan for the transportation device 21 is not guaranteed. A mechanism for sharing management information of the transportation device 11 and management information of the transportation device 21 between the control device 12 and the control device 22 is not provided.

In other words, the control device 12 and the control device 22 are designed and manufactured, as described above, by manufactures different from each other. Therefore, the control device 12 and the control device 22 may receive, for example, operations by operators different from each other. In the control device 12 and the control device 22, for example, communication protocols to be used for communicating with a control target may be different from each other. In the control device 12 and the control device 22, for example, systems may be different from each other.

According to the present example embodiment, the transportation system 1 and the transportation system 2 are systems designed and manufactured by different manufacturers, but the present invention is not limited thereto. In other words, the transportation system 1 and the transportation system 2 may be systems designed and manufactured by the same manufacturer. Also, according to such an aspect, a difference in operation system or a difference in communication protocol may occur between the transportation system 1 and the transportation system 2, depending on a difference in version or the like. Therefore, a status in which the transportation device 11 is not under control of the control device 22 and a status in which the transportation device 21 is not under control of the control device 12 may occur, not only when the transportation system 1 and the transportation system 2 are systems designed and manufactured by different manufacturers but also when the transportation system 1 and the transportation system 2 are systems having different versions.

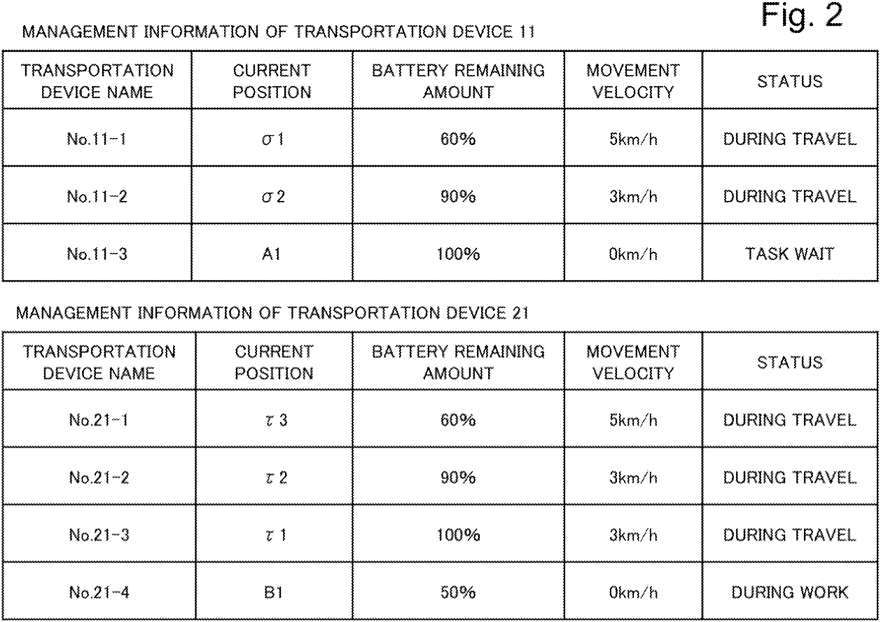

The management information of the transportation device 11 and the management information of the transportation device 21 are explained. FIG. 2 is a diagram explaining a specific example of management information. As illustrated in FIG. 2, the management information of the transportation device 11 is information including, for example, a current position of the transportation device 11, a battery remaining amount, a movement velocity, and a status (during travel, during work, task wait, intersection wait, obstacle stop, an error, or the like). The management information of the transportation device 21 is similar thereto.

### Configuration of Transportation System and Flow of Control Method

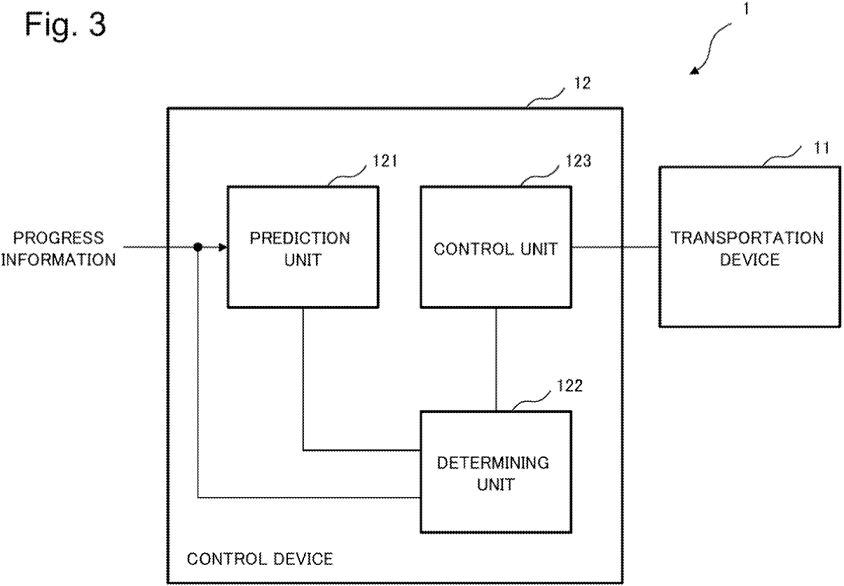

A configuration of the transportation system 1 is explained with reference to FIG. 3. FIG. 3 is a block diagram illustrating a configuration of the transportation system 1.

The transportation system 1 includes a transportation device 11 and a control device 12. The control device 12 includes a prediction unit 121, a determining unit 122, and a control unit 123.

The prediction unit 121 is configured to predict, based on the progress information 31 acquired from the production management device 3, a travel status of the transportation device 21 being not under control of the control device 12.

The determining unit 122 is configured to determine a travel plan for the transportation device 11 under control of the control device 12, according to the progress information 31 acquired from the production management device 3 and a travel status of the transportation device 21 which is predicted by the prediction unit 121.

The control unit 123 is configured to provide, for the transportation device 11, a travel plan for the transportation device 11 determined by the determining unit 122.

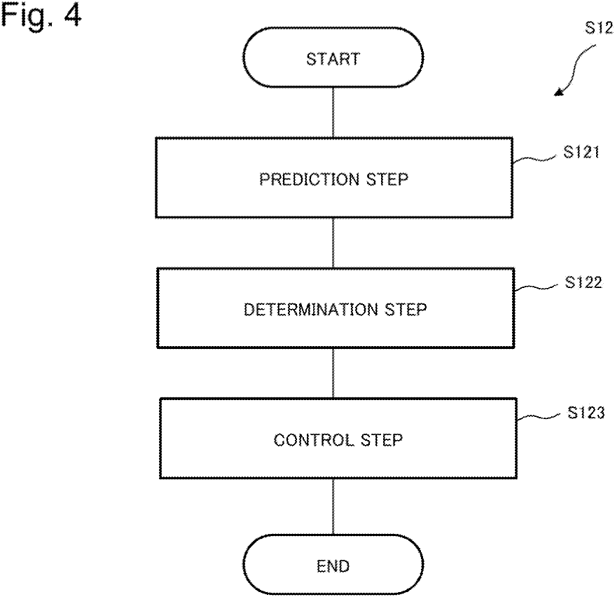

A flow of a control method S12 of controlling, by the control device 12, the transportation device 11 is explained with reference to FIG. 4. FIG. 4 is a flowchart illustrating the flow of the control method S12.

The control method S12 includes a prediction step S121, a determination step S122, and a control step S123. The prediction step S121 is processing for predicting, based on the progress information 31 acquired from the production management device 3, a travel status of the transportation device 21 being not under control of the control device 12 and is executed by the prediction unit 121. The determination step S122 is processing for determining, according to the progress information 31 acquired from the production management device 3 and the travel status of the transportation device 21 predicted in the prediction step S121, a travel plan for the transportation device 11 under control of the control device 12 and is executed by the determining unit 122. The control step S123 is processing for providing, for the transportation device 11, the travel plan determined in the determination step S122 and is executed by the control unit 123.

Herein, in the determination step S122, the determining unit 122 determines a travel plan for the transportation device 11, for example, in such a way as not to prohibit predicted travel of the transportation device 21. The determining unit 122 determines a travel plan for the transportation device 11, for example, in such a way, as described later, that the transportation device 11 does not travel in a transportation path where it is highly possible that the transportation device 21 is traveling or in a transportation path intersecting with the transportation path. Alternatively, the determining unit 122 determines a travel plan for the transportation device 11 in such a way, as described later, that the transportation device 11 does not travel in a region including a current position (x, y) of the transportation device 21. Alternatively, the determining unit 122 determines a travel plan for the transportation device 11 in such a way that the transportation device 11 travels in a transportation path where it is less possible that the transportation device 21 is traveling. Alternatively, the determining unit 122 estimates, with respect to a predetermined transportation path, a time at which it is highly possible that the transportation device 21 is traveling in the transportation path and determines a travel plan for the transportation device 11 in such a way that the transportation device 11 does not travel in the transportation path at the time. An aspect in which a travel plan for the transportation device 11 is determined in such a way that the transportation device 11 does not travel in a certain transportation path includes, for example, an aspect in which the transportation device 11 is caused to use a transportation path other than the transportation path, an aspect in which the transportation device 11 is stopped before the transportation device 11 intrudes into the transportation path, and the like.

In the control step S123, the control unit 123 provides a travel plan for the transportation device 11 and thereby controls the transportation device 11. A matter that the transportation device 11 is controlled includes a matter that in accordance with the provided travel plan, the transportation device 11 operates based on autonomous determination. A mater that the transportation device 11 is controlled includes a matter that a command based on the travel plan is issued to the transportation device 11 and thereby, the transportation device 11 operates.

Processing of acquiring the progress information 31 from the production management device 3 may be executed before the control method S12 is started or may be executed by the prediction unit 121 before the prediction step S121.

Herein, a travel status of the transportation device 21 represents a status of the transportation device 21. The travel status of the transportation device 21 can be represented based on various types of information representing a status of the transportation device 21 during travel. As examples of various types of information, a probability Pi, a current position to be described later, and the like are cited but not limited thereto.

For example, a travel status of the transportation device 21 is predicted, as described later as a first specific example of the prediction step S121, as a probability Pi in which in each transportation path τi, the transportation device 21 is traveling. In this case, in the determination step S122, the determining unit 122 sets, as a travel-prohibited path, a transportation path intersecting with a transportation path τi having a probability Pi in which the transportation device 21 is traveling, which is equal to or more than a previously-determined threshold, from among transportation paths α1 to α3 to be used by the transportation device 11. As one example, when a probability P2 in which the transportation device 21 is traveling in the transportation path τ2 is equal to or more than a previously-determined threshold, from among the transportation paths σ1 to σ3 to be used by the transportation device 11, the transportation path σ2 intersecting with the transportation path τ2 is set as a travel-prohibited path (see FIG. 1). In the determination step S122, the determining unit 122 determines, under a constrained condition in that “the transportation device 11 does not travel in a travel-prohibited path”, a travel plan for the transportation device 11 under control of the control device 12. An algorithm e for determining a travel plan for the transportation device 11 under the above-mentioned constrained condition is not limited to the above-mentioned algorithm. As an algorithm for determining a travel plan, for example, linear programming, dynamic programing, a genetic algorithm, and the like are cited.

A travel status of the transportation device 21 is predicted, as described later as a second specific example of the prediction step S121, as a current position (x, y) of the transportation device 21. In this case, in the determination step S122, the determining unit 122 sets, as a travel-prohibited region, a region including the current position (x, y) of the transportation device 21, for example, a circular region where a distance from the current position (x, y) of the transportation device 21 is equal to or less than a previously-determined threshold. In the determination step S122, the determining unit 122 determines, under a constrained condition in that “the transportation device 11 does not travel in a travel-prohibited path”, a travel plan for the transportation device 11 under control of the control device 12. An algorithm for determining a travel plan for the transportation device 11 under the above-mentioned constrained condition is not limited to the above-mentioned algorithm. As the algorithm for determining a travel plan, for example, linear programming, dynamic programing, a genetic algorithm, and the like are cited.

Herein, it is difficult to acquire some or all of current positions (x, y) of the transportation device 21, and therefore these positions are predicted based on the prediction step S121. While details are described later, specific prediction methods include a method for acquisition from the production management device 3, a method for estimation based on an image captured by a camera (not illustrated) installed on a ceiling or the like, a method for estimation based on an image captured by a camera (not illustrated) included in the transportation device 11, and the like.

### Specific Example of Progress Information

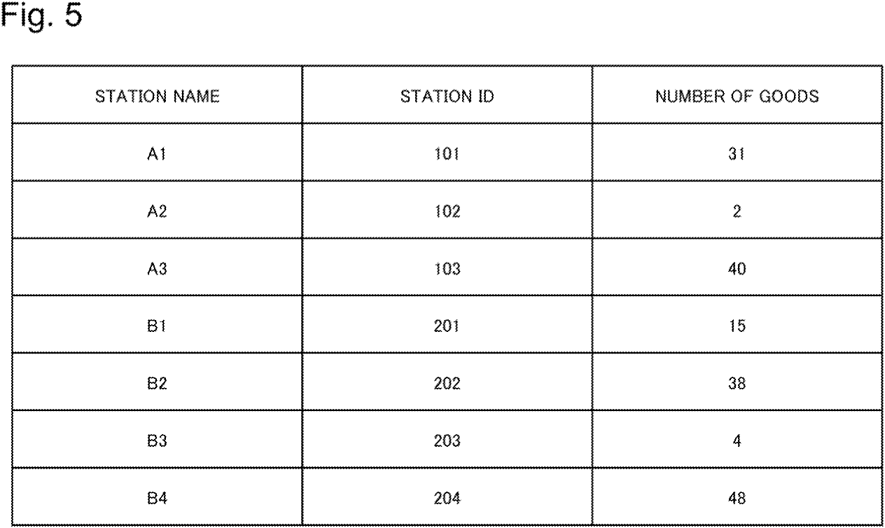

One specific example of the progress information 31 provided from the production management device 3 is explained with reference to FIG. 5. FIG. 5 is a data structure diagram illustrating one specific example of the progress information 31.

In the present specific example, the progress information 31 is information indicating a progress status of work at each station disposed in the factory F and is a table storing, for example, an ID of each station and a progress status of work at the station in association with each other. In the present specific example, the progress status of work at each station is represented by the number of goods in which work at the station is competed and transportation to a next station is awaited.

The progress information 31 exemplarily illustrated in FIG. 5 indicates the following. As stations A1 to A3 and stations B1 to B4 in the following explanation, the stations exemplarily illustrated in FIG. 1 are assumed.
At the station A1 in which an ID is 101, thirty-one goods in which work at the station A1 is completed and transportation to the next station A2 is awaited are accumulated.
At the station A2 in which an ID is 102, two goods in which work at the station A2 is completed and transportation to the next station A3 is awaited are accumulated.
At the station A3 in which an ID is 103, forty goods in which work at the station A3 is completed are accumulated.
At the station B1 in which an ID is 201, fifteen goods in which work at the station B1 is completed and transportation to the next station B2 is awaited are accumulated.
At the station B2 in which an ID is 202, thirty-eight goods in which work at the station B2 is completed and transportation to the next station B3 is awaited are accumulated.
At the station B3 in which an ID is 203, four goods in which work at the station B3 is completed and transportation to the station B4 is awaited are accumulated.
At the station B4 in which an ID is 204, forty-eight goods in which work at the station B4 is completed are accumulated.

One example of prediction processing using the progress information 31 exemplarily illustrated in FIG. 5 is explained. The control device 12 determines that the number (thirty-eight) of goods in which work at the station B2 is completed and transportation to the next station B3 is awaited is large. The information indicates that work at the station B2 is in a state immediately before completion and movement of the transportation device 21 having loaded goods at the station B2 to the next station B3 is likely to occur. From the information, the control device 12 supposes that movement (return) of the transportation device 21 having unloaded goods at the station B2 to the previous station B1 is likely to occur. The control device 12 predicts a travel status of the transportation device 21, based on determination in that movement (return) of the transportation device 21 having unloaded goods at the station B2 to the previous station B1 is likely to occur.

Another example of prediction processing using the progress information 31 exemplarily illustrated in FIG. 5 is explained. The control device 12 determines that the number (four) of goods in which work at the station B3 is completed and transportation to the next station B4 is awaited is small (nearly zero). The information indicates that work at the station B3 is in a state immediately after start and movement of the transportation device 21 having loaded goods at the station B3 to the next station B4 is unlikely to occur. From the information, the control device 12 supposes that movement (return) of the transportation device 21 having unloaded goods at the station B3 to the previous station B2 is unlikely to occur. The control device 12 predicts a travel status of the transportation device 21, based on determination in that movement (return) of the transportation device 21 having unloaded goods at the station B3 to the previous station B2 is unlikely to occur.

As a condition for determining that the number of goods is large or small, the control device 12, for example, may set a threshold for a number or may execute determination, based on an occupancy of a maximum number of accumulable goods.

The production management device 3 periodically updates the progress information 31 and periodically provides the updated progress information 31 for each of the control device 12 and the control device 22. A period in which the production management device 3 provides the progress information 31 may be the same as a period in which the production management device 3 updates the progress information 31 or may be longer than the period in which the production management device 3 updates the progress information 31. The control device 12 executes, every time the updated progress information 31 is acquired, the prediction step S121 based on the updated progress information 31.

### First Specific Example of Prediction Processing

A first specific example of the prediction step S121 to be executed by the prediction unit 121 of the control device 12 is explained. The prediction step S121 according to the present specific example is processing of predicting a probability Pi in which in each transportation path τi, the transportation device 21 is traveling.

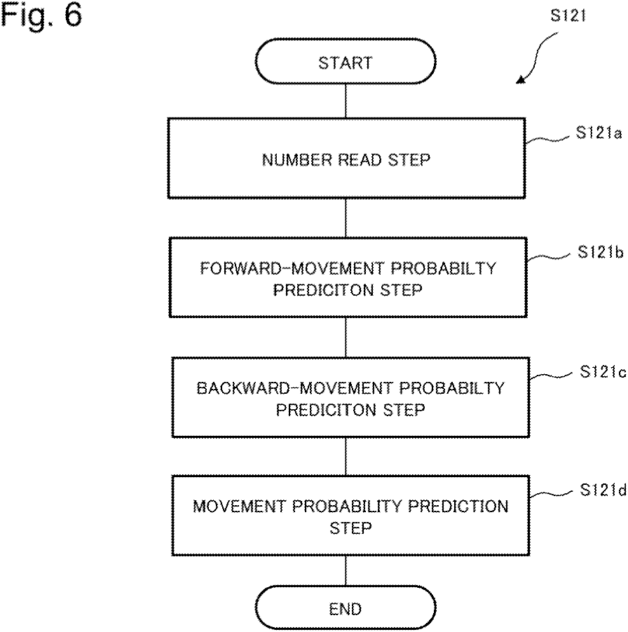

FIG. 6 is a flowchart illustrating a flow of the prediction step S121 according to the present specific example. The prediction step S121 according to the present specific example includes, as illustrated in FIG. 6, a number read step S121a, a forward-movement probability prediction step S121b, a backward-movement probability prediction step S121c, and a movement probability prediction step S121d. An operation of the prediction unit 121 in each step is explained, as follows.

The number read step S121a is a step of reading, from the progress information 31, a number zi of goods in which work at each station Bi is completed and transportation to a next station Bi+1 is awaited.

The forward-movement probability prediction step S121b is a step of predicting a probability Pi→i+1 in which the transportation device 21 having loaded goods at each station Bi is moving to a next station Bi+1. The prediction is executed, for example, by using a function P⁺(zi) where input is a number zi of goods in which work at the station Bi is completed and transportation to the next station Bi+1 is awaited and where output is a probability Pi→i+1. The prediction unit 121 predicts that, for example, as a number zi of goods in which work in a station Bi is completed and transportation to the next station Bi+1 is awaited is larger, a probability Pi→i+1 in which the transportation device 21 is moving from the station Bi to the next station Bi+1 is higher. The function P⁺(zi) may be a continuous function such as a linear function or a quadratic function or may be a discontinuous function such as a step function.

The backward-movement probability prediction step S121c is a step of predicting a probability Pi→i-1 in which the transportation device 21 having unloaded goods at each station Bi is moving to a previous station Bi-1. The prediction is executed, for example, by using a function P⁻(zi) where input is a number zi of goods in which work at the station Bi is completed and transportation to the next station Bi+1 is awaited and where output is a probability Pi→i-1. The prediction unit 121 predicts that, for example, as a number zi of goods in which work at the station Bi is completed and transportation to the next station Bi+1 is awaited is larger, a probability Pi→i-1 in which the transportation device 21 is moving from the station Bi to a previous station Bi-1 is higher. The function P⁻(zi) may be a continuous function such as a linear function or a quadratic function or may be a discontinuous function such as a step function.

The prediction unit 121 may execute prediction processing for a travel status of the transportation device 21, based on a timing of a change in a number zi of goods awaiting transportation and an elapsed time from the timing. The prediction unit 121 can suppose that, for example, as an elapsed time from a timing at which a number zi has been changed is shorter, a probability in which the transportation device 21 is present at the station is higher.

The movement probability prediction step S121d is a step of predicting a probability Pi in which in each transportation path τi, the transportation device 21 is traveling. The prediction is executed, for example, by calculating a probability Pi in accordance with an expression Pi={(Pi→i+1)+(Pi +1→i)}/2. Herein, the probability Pi→i+1 is a probability in which the transportation device 21 having loaded goods in the station Bi being a start point of the transportation path τi is moving to the next station Bi+1 and is acquired in the forward-movement probability prediction step S121b. The probability Pi+1→i is a probability in which the transportation device 21 having unloaded goods in the station Bi+1 being an end point of the transportation path τi is moving to the previous station Bi and is acquired in the backward-movement probability prediction step S121c.

Herein, a form in which after the forward-movement probability prediction step S121b is executed, the backward-movement probability prediction step S121c is executed has been explained, but an execution order of these steps is not limited thereto. In other words, after the backward-movement probability prediction step S121c is executed, the forward-movement probability prediction step S121b may be executed, or the forward-movement probability prediction step S121b and the backward-movement probability prediction step S121c may be simultaneously executed in parallel.

There is a certain correlation between the progress information 31 and the probability Pi in which in each transportation path τi, the transportation device 21 is traveling. Therefore, a leaned model in which input is the progress information 31 and output is a probability in which in each transportation path τi, the transportation device 21 is traveling can be constructed based on machine learning. The prediction unit 121 may execute prediction processing, by using such a learned model. In this case, the control device 12 may include a leaning unit that constructs such a learned model. The machine learning may be supervised learning, unsupervised learning, reinforcement learning, or a combination thereof. The machine learning may be deep learning. In other words, the learned model may be a neural network including an intermediate layer.

### Second Specific Example of Prediction Processing

A second specific example of the prediction step S121 to be executed by the prediction unit 121 of the control device 12 is explained. The prediction step S121 according to the present specific example is processing of predicting a current position (x, y) of the transportation device 21.

In the present specific example, it is assumed that transportation paths τ1 to τ3 to be used by the transportation device 21 are previously given to the control device 12. Alternatively, it is assumed that map information including positions of stations B1 to B4 to be used by the transportation device 21, a wait location, a charge location, and the like is previously given to the control device 12 and the control device 12 can estimate the transportation paths τ1 to τ3 from the positions of the stations B1 to B4. For example, a transportation path τi from a station Bi to a station Bi+1 can be configured by combining a previously-determined shortest path from the station Bi to a main street, a path passing along the main street, and a shortest path from the main street to the station Bi+1. In the present specific example, it is assumed that a maximum number wi of transportation-waiting goods accumulated at each station Bi is previously given to the control device 12. In the present specific example, it is assumed that a velocity v of the transportation device 21 is previously given to the control device 12.

Herein, the “main street” is explained. The main street is a passage being a main line among transportation paths of the transportation device 11 or the transportation device 21 and is a passage where there are many transportation devices to be used, compared with surrounding passages. Each of the transportation path of the transportation device 11 and the transportation path of the transportation device 21 is designed by including the main street, according to a space (a factory, a warehouse, or the like) where goods are transported. The transportation path is often designed in such a way that the transportation device 11 or the transportation device 21 travels in the main street as many times as possible. As a result, the transportation path of the transportation device 11 and the transportation path of the transportation device 21 each include a path from a station to the main street and a path passing along the main street.

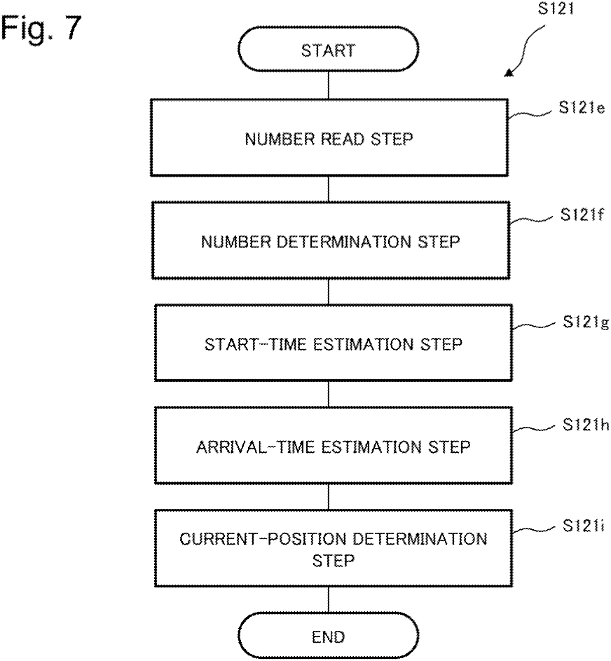

In the present specific example, with regard to movement from the station B1 to the station B2, a time t1 at which the transportation device 21 starts from the station B1 and a time t2 at which the transportation device 21 arrives at the station B2 are estimated, and a current position (x, y) of the transportation device 11 is predicted in a period from the time t1 to the time t2. Also, with regard to movement from the station B2 to the station B3 and movement from the station B3 to the station B4, similar prediction is performed. Also, with regard to return from the station B2 to the station B1, return from the station B3 to the station B2, and return from the station B4 to the station B3, similar prediction is performed. Herein, a specific example of the prediction step S121 with respect to movement from the station B2 to the station B3 is explained, with reference to FIG. 7.

FIG. 7 is a flowchart illustrating a flow of the prediction step S121 according to the present specific example. The prediction step S121 according to the present specific example includes, as illustrated in FIG. 7, a number read step S121e, a number determination step S121f, a start-time estimation step S121g, an arrival-time estimation step S121h, and a current-position estimation step S121i. An operation of the prediction unit 121 in each step is explained, as follows.

The number read step S121e is a step of reading, a number z2 of goods in which work at the station B2 is completed and transportation to the next station B3 is awaited, from the progress information 31.

The number determination step S121f is a step of determining whether a number z2 of goods in which work at the station B2 is completed and transportation to the next station B3 is awaited reaches a previously determined maximum number w2. The number determination step S121f is repeatedly executed until a number z2 reaches the maximum number w2, and when the number z2 reaches the maximum number w2, a next start-time estimation step S121g is executed.

The start-time estimation step S121g is a step of estimating a time t2 at which the transportation device 21 starts from the station B2. In the present step, for example, a current time at which the start-time estimation step S121g is executed, i.e., a current time at which the number z2 reaches the maximum number w2 is estimated as a time t2 at which the transportation device 21 starts from the station B2.

The arrival-time estimation step S121h is a step of estimating a time t3 at which the transportation device 21 arrives at the station B3. In the present step, for example, a length of the transportation path τ2 is designated as L2 and a time calculated in accordance with an expression t3=t2+L2/v is estimated as a time t3 at which the transportation device 21 arrives at the station B3.

The current-position estimation step S121i is a step of estimating a current position (x, y) of the transportation device 21 in a period from the time t2 to the time t3. In the present step, for example, a position of a point where along the transportation path τ2, an advance is made by a distance vx(t-t2) from the station B2 is estimated as a current position (x, y) of the transportation device 21 at a current time t.

In the arrival-time estimation step S121h and the current-position estimation step S121i, a temporary stop of the transportation device 21 which may occur at an intersection, an automatic door, or the like may be considered. In other words, when the transportation path τ2 passes through an intersection or an automatic door, in the arrival-time estimation step S121h, a time required for a temporary stop may be added to the time t3 at which the transportation device 21 arrives at the station B3. In the current-position estimation step S121i, a temporary stop occurring at an intersection, an automatic door, or the like is considered and thereby, the current position (x, y) of the transportation device 21 may be estimated.

Between the progress information 31 and a current time t, and the current position (x, y) of the transportation device 21 in each transportation path τi, there is a certain correlation. Therefore, a leaned model in which input is the progress information 31 and the current time t and output is the current position (x, y) of the transportation device 21 in each transportation path τi can be constructed based on machine learning. The prediction unit 121 may execute prediction processing, by using such a learned model. In this case, the control device 12 may include a learning unit that constructs such a learned model. The machine learning may be supervised learning, unsupervised learning, reinforcement learning, or a combination thereof. The machine learning may be deep learning. In other words, a learned model may be a neural network including an intermediate layer.

### Another Specific Example of Prediction Processing

The control device 22 determines, in accordance with a previously-determined algorithm (also referred to as “a transportation policy” in some cases), a travel plan for the transportation device 21 from the progress information 31. Therefore, between the progress information 31 and the travel plan for the control device 22, there is a certain correlation. Therefore, a learned model in which input is the progress information 31 and output is the travel plan for the transportation device 21 can be constructed based on machine learning. The prediction unit 121 may execute prediction processing, by using such a learned model. In this case, the control device 12 may include a learning unit that constructs such a learned model. The machine learning may be supervised learning, unsupervised learning, reinforcement learning, or a combination thereof. The machine learning may be deep learning. In other words, a learned model may be a neural network including an intermediate layer. When such a learned model is constructed based on supervised learning, a combination of past progress information 31 and a past travel plan (travel result) of the transportation device 21 may be used as supervised data.

### Hardware Configuration and Achievement Example Based on Software

Each block of the control device 12 included in the transportation system 1 according to the present example embodiment may be achieved by a logic circuit (hardware) formed on an integrated circuit (IC) chip or the like or may be achieved by a program (software) by using a central processing unit (CPU). In the latter case, the control device 12 can be achieved by using a general-purpose computer (electronic computer) operating in accordance with a given program.

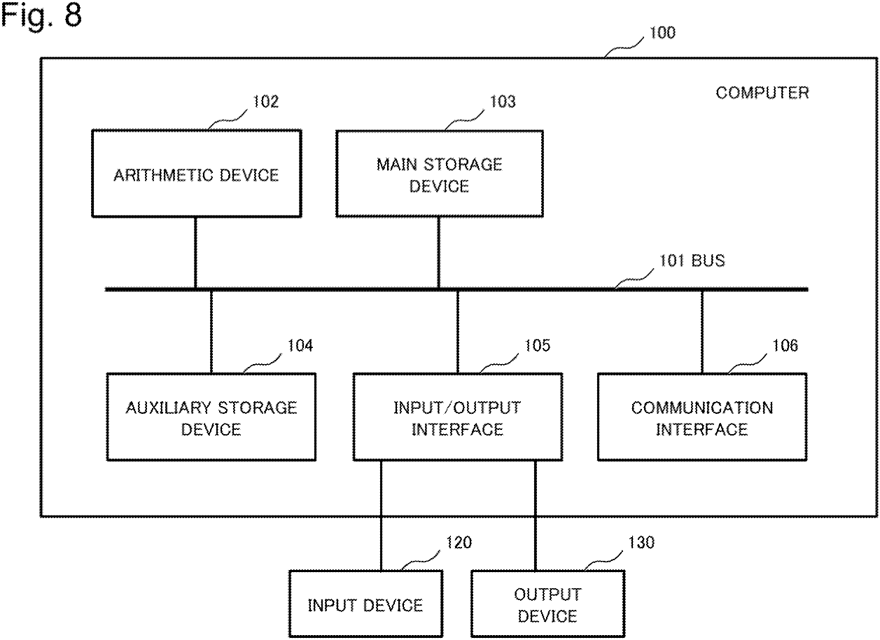

FIG. 8 is a block diagram illustrating a configuration of a computer 100 for achieving the control device 12. The computer 100 includes an arithmetic device (processor) 102, a main storage device (main memory) 103, an auxiliary storage device (sub-memory) 104, an input/output interface 105, and a communication interface 106 connected to each other via a bus 101. The arithmetic device 102, the main storage device 103, and the auxiliary storage device 104 each may be, for example, a CPU, a random access memory (RAM), and a hard disk drive. The input/output interface 105 is connected, for example, with an input device 120 for inputting, by a user, various types of information to the computer 100 and an output device 130 for outputting, by the computer 100, various types of information to a user. The input device 120 and the output device 130 may be built in the computer 100 or may be connected (or externally attached) to the computer 100. For example, the input device 120 may be a keyboard, a mouse, a touch sensor, or the like, and the output device 130 may be a display, a printer, a speaker, or the like. A device including a function of both of the input device 120 and the output device 130 such as a touch panel in which a touch sensor and a display are integrated may be applicable. The communication interface 106 is an interface for communicating, by the computer 100, with an external device. Communication between the control device 12 and the transportation device 11 and communication between the control device 12 and the production management device 3 can be performed by using the communication interface 106.

The auxiliary storage device 104 stores a program for causing the computer 100 to function as each unit of the control device 12. In other words, the auxiliary storage device 104 stores a program for executing each step of the control method S12. The arithmetic device 102 executes a command included in the program developed on the main storage device 103 and thereby, causes the computer 100 to function as each unit of the control device 12. A recording medium to be used for recording, by the auxiliary storage device 104, information such as the program may be a computer-readable “non-transitory, tangible medium” and may be, for example, a tape, a disk, a card, a semiconductor memory, or a programmable logic circuit.

Herein, a configuration in which the program stored in a single storage device is executed by a single arithmetic device has been explained, but not limited thereto. In other words, the program may be decentrally stored in a plurality of storage devices or may be decentrally executed by a plurality of arithmetic devices.

A configuration in which the computer 100 is caused to function by using the program recorded in an external recording medium of the computer 100 or the program supplied to the computer 100 via any transmission medium (a communication network, a broadcast wave, or the like) may be employed. The present invention can be also achieved by using a form of a data signal embedded in a carrier wave in which the program is embodied based on electronic transmission.

### Application to Logistics in Warehouse

The transportation system 1 according to the present example embodiment is used for production in a factory, but the present invention is not limited thereto. In other words, the transportation system according to the present invention can be used for any work involving transportation of goods.

The transportation system according to the present invention can be used, for example, for logistics in a warehouse. In a warehouse, for example, a first transportation system relevant to the transportation system 1 according to the present example embodiment, a second transportation system relevant to the transportation system 2 according to the present example embodiment, and a logistics management device relevant to the production management device 3 according to the present example embodiment are introduced. In this case, progress information is provided from the logistics management device that integrally manages logistics in a warehouse to each of a control device of the first transportation system and a control device of the second transportation system. The control device of the first transportation system can predict, based on the progress information provided from the logistics management device, a travel status of a transportation device of the second transportation system, similarly to the control device 12 according to the present example embodiment. The control device of the first transportation system can determine, based on the progress information provided from the logistics management device and the predicted travel status of the transportation device of the second transportation system, a travel plan for a transportation device of the first transportation system, similarly to the control device 12 according to the present example embodiment.

With regard to logistics in a warehouse, a picking instruction to the control device of each transportation system may be broadcast by the logistics management device. In this case, the control device of the first transportation system can acquire the picking instruction to the control device of the second transportation system. The picking instruction includes information of a packing style, a production progress of transportation goods, a location of transportation goods, a delivery number/delivery deadline of designated products (transportation goods), lot management, and the like. In this case, the control device of the first transportation system can specify, from the picking instruction to the control device of the second transportation system, a timing at which the transportation device of the second transportation system starts moving. In other words, when the above-described second specific example of the prediction step S121 is applied, a step (the start-time estimation step S121g) of estimating, based on the progress information 31 acquired from the production management device 3, a start time of the transportation device 21 of the transportation system 2 can be replaced with a step of estimating, based on the picking instruction acquired from the logistics management device, a start time of the transportation device of the second transportation system.

With regard to logistics in a warehouse, an accumulation location of goods may be set for each day of a week. In this case, the control device of the first transportation system can estimate a transportation path where the transportation device of the second transportation system travels from a day of a week based on the day.

### Second Example Embodiment

A control device 1000 according to a second example embodiment of the present invention is explained with reference to a drawing.

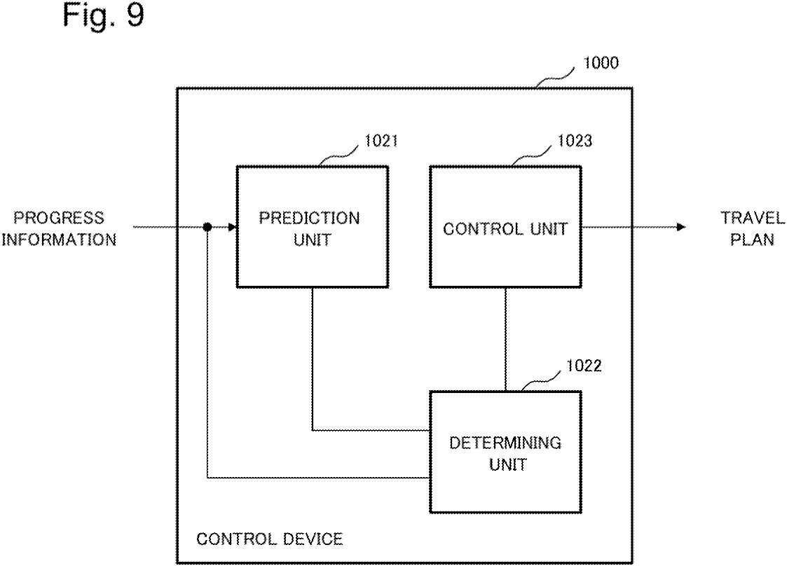

FIG. 9 is a block diagram illustrating a configuration of the control device 1000.

### Configuration of Control Device 1000

The control device 1000 includes a prediction unit 1021, a determining unit 1022, and a control unit 1023. The prediction unit 1021 predicts, based on progress information representing a progress of work involving transportation of goods, a travel status of a second transportation device being used for the work. The determining unit 1022 determines, according to the travel status, a travel plan for a first transportation device being used for the work. The control unit 1023 controls, based on the travel plan, the first transportation device.

The control device 1000 can be configured by using the computer 100 illustrated in FIG. 8, similarly to the control device 12 according to the first example embodiment.

### Operation of Control Device 1000

In the control device 1000 configured as described above, the prediction unit 1021 executes a prediction step of predicting, based on progress information representing a progress of work involving transportation of goods, a travel status of a second transportation device being used for the work; the determining unit 1022 executes a determination step of determining, according to the travel status, a travel plan for a first transportation device being used for the work; and the control unit 1023 executes a control step of controlling, based on the travel plan, the first transportation device.

### Advantageous Effect of Control Device 1000

The control device 1000 according to the present example embodiment can determine, between a first transportation device and a second transportation device that are used for work involving transportation of goods, a travel plan for the first transportation device under control of a local device in such a way that transportation efficiency of each of the first transportation device and the second transportation device is unlikely to decrease.

### Supplementary Information

According to each example embodiment, a transportation system, a control method, and a control device can be described as, but not limited to, the following supplementary notes.

Supplementary note 1: A transportation system comprising: a first transportation device being used for work involving transportation of goods; and a control device, wherein the control device includes a prediction means for predicting, based on progress information representing a progress of the work, a travel status of a second transportation device being used for the work, a determining means for determining a travel plan for the first transportation device according to the travel status of the second transportation device that is predicted by the prediction means, and a control means for controlling, based on the travel plan, the first transportation device.

According to the above-mentioned configuration, a travel plan for the first transportation device under control of a local device can be determined according to the travel status of the second transportation device. Therefore, the travel plan for the first transportation device can be determined in such a way that, for example, a situation in which the first transportation device travels in a transportation path intersecting with a transportation path where the second transportation device is traveling and a situation in which the first transportation device travels in a vicinity of a current position of the second transportation device are unlikely to occur. Therefore, a travel plan for the first transportation device can be determined in such a way that a collision avoidance function of one or both of the first transportation device and the second transportation device works or the like and thereby, transportation efficiency is unlikely to decrease.

Supplementary note 2: The transportation system according to supplementary note 1, wherein the progress information is information acquired from a management device that integrally manages the work.

According to the above-mentioned configuration, the travel status of the second transportation device can be predicted based on the progress information acquired from the management device. Therefore, the travel status of the second transportation device can be predicted more simply.

Supplementary note 3: The transportation system according to supplementary note 1 or 2, wherein the second transportation device is controlled by another control device different from the control device.

According to the above-mentioned confirmation, a travel status of the second transportation device being controlled by another control device can be predicted.

Supplementary note 4: The transportation system according to any one of supplementary notes 1 to 3, wherein the prediction means predicts, as the travel status, a probability that the second transportation device is traveling in each transportation path.

According to the above-mentioned configuration, a travel plan for the first transportation device can be determined based on the probability in which the second transportation device is traveling in each transportation path.

Supplementary note 5: The transportation system according to any one of supplementary notes 1 to 3, wherein the prediction means predicts, as the travel status, a current position of the second transportation device.

According to the above-mentioned configuration, a travel plan for the first transportation device can be determined based on the current position of the second transportation device.

Supplementary note 6: The transportation system according to any one of supplementary notes 1 to 5, wherein the determining means specifies, based on the travel status, a travel-prohibited path and determines, based on information of the travel-prohibited path and the progress information, a travel plan for the first transportation device.

According to the above-mentioned configuration, a travel plan for the first transportation device can be determined in such a way that a situation in which travel is performed in a travel-prohibited path is unlikely to occur.

The transportation system according to any one of supplementary notes 1 to 6, wherein the second transportation device is not under control of the control device, is also included in the scope of the present invention.

According to the above-mentioned configuration, even when the second transportation device is not under control of a local device, a travel plan for the first transportation device can be determined in such a way that transportation efficiency is unlikely to decrease.

Supplementary note 7: A control method comprising, by a control device: predicting, based on progress information representing a progress of work involving transportation of goods, a travel status of a second transportation device being used for the work; determining, according to the travel status, a travel plan for a first transportation device being used for the work; and controlling, based on the travel plan, the first transportation device.

According to the above-mentioned configuration, an advantageous effect similar to supplementary note 1 is exhibited.

Supplementary note 8: The control method according to supplementary note 7, wherein the progress information is information acquired from a management device that integrally manages the work.

According to the above-mentioned configuration, an advantageous effect similar to supplementary note 2 is exhibited.

Supplementary note 9: The control method according to supplementary note 7 or 8, wherein the second transportation device is controlled by another control device.

According to the above-mentioned configuration, an advantageous effect similar to supplementary note 3 is exhibited.

Supplementary note 10: The control method according to any one of supplementary notes 7 to 9, further comprising predicting, as the travel status, a probability that the second transportation device is traveling in each transportation path.

According to the above-mentioned configuration, an advantageous effect similar to supplementary note 4 is exhibited.

Supplementary note 11: The control method according to any one of supplementary notes 7 to 9, further comprising predicting, as the travel status, a current position of the second transportation device.

According to the above-mentioned configuration, an advantageous effect similar to supplementary note 5 is exhibited.

Supplementary note 12: The control method according to any one of supplementary notes 7 to 11, further comprising: specifying, based on the travel status, a travel-prohibited path; and determining, based on information of the travel-prohibited path and the progress information, a travel plan for the first transportation device.

According to the above-mentioned configuration, an advantageous effect similar to supplementary note 6 is exhibited.

The control method according to any one of supplementary notes 8 to 12, wherein the second transportation device is not under control of the control device, is also included in the scope of the present invention.

According to the above-mentioned configuration, even when the second transportation device is not under control of a local device, a travel plan for the first transportation device can be determined in such a way that transportation efficiency is unlikely to decrease.

Supplementary note 13: A control device comprising: a prediction means for predicting, based on progress information representing a progress of work involving transportation of goods, a travel status of a second transportation device being used for the work; a determining means for determining, according to the travel status, a travel plan for a first transportation device being used for the work; and a control means for controlling, based on the travel plan, the first transportation device.

According to the above-mentioned configuration, an advantageous effect similar to supplementary note 1 is exhibited.

Supplementary note 14: The control device according to supplementary note 13, wherein the progress information is information acquired from a management device that integrally manages the work.

According to the above-mentioned configuration, an advantageous effect similar to supplementary note 2 is exhibited.

Supplementary note 15: The control device according to supplementary note 13 or 14, wherein the second transportation device is controlled by another control device different from the control device.

According to the above-mentioned configuration, an advantageous effect similar to supplementary note 3 is exhibited.

Supplementary note 16: The control device according to any one of supplementary notes 13 to 15, wherein the prediction means predicts, as the travel status, a probability that the second transportation device is traveling in each transportation path.

According to the above-mentioned configuration, an advantageous effect similar to supplementary note 4 is exhibited.

Supplementary note 17: The control device according to any one of supplementary notes 13 to 15, wherein the prediction means predicts, as the travel status, a current position of the second transportation device.

According to the above-mentioned configuration, an advantageous effect similar to supplementary note 5 is exhibited.

Supplementary note 18: The control device according to any one of supplementary notes 13 to 17, wherein the determining means specifies, based on the travel status, a travel-prohibited path, and determines, based on information of the travel-prohibited path and the progress information, a travel plan for the first transportation device.

According to the above-mentioned configuration, an advantageous effect similar to supplementary note 6 is exhibited.

The control device according to any one of supplementary notes 15 to 18, wherein the second transportation device is not under control of the control device, is also included in the scope of the present invention.

According to the above-mentioned configuration, even when the second transportation device is not under control of a local device, a travel plan for the first transportation device can be determined in such a way that transportation efficiency is unlikely to decrease.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

REFERENCE SIGNS LIST

| | |
|---|---|
| 1 | Transportation system |
| 11 | Transportation device (first transportation device) |
| 12 | Control device |
| 121 | Prediction unit |
| 122 | Determining unit |
| 123 | Control unit |
| 2 | Transportation system (another transportation system) |
| 21 | Transportation device (second transportation device) |
| 22 | Control device |
| 3 | Production management device (management device) |

What is claimed is:

1. A transportation system comprising: a first transportation device that is used for work involving transportation of goods; and a control device that controls the first transportation device, wherein
the control device includes one or more memories storing instructions and one or more processors configured to execute the instructions to
predict, based on progress information representing a progress of the work, a travel status of a second transportation device being used for the work,
determine a travel plan for the first transportation device according to the travel status of the second transportation device that is predicted, and
control, based on the travel plan, the first transportation device.

2. The transportation system according to claim 1, wherein
the progress information is information acquired from a management device that integrally manages the work.

3. The transportation system according to claim 1, wherein
the second transportation device is controlled by another control device different from the control device.

4. The transportation system according to claim 1, wherein
the one or more processors are configured to execute the instructions to predict, as the travel status, a probability that the second transportation device is traveling in each transportation path.

5. The transportation system according to claim 1, wherein
the one or more processors are configured to execute the instructions to predict, as the travel status, a current position of the second transportation device.

6. The transportation system according to claim 1, wherein
the one or more processors are configured to execute the instructions to specify, based on the travel status, a travel-prohibited path, and determine, based on information of the travel-prohibited path and the progress information, a travel plan for the first transportation device.

7. A control method comprising:
predicting, based on progress information representing a progress of work involving transportation of goods, a travel status of a second transportation device being used for the work;
determining, according to the travel status, a travel plan for a first transportation device being used for the work; and
controlling, based on the travel plan, the first transportation device.

8. The control method according to claim 7 wherein
the progress information is information acquired from a management device that integrally manages the work.

9. The control method according to claim 7, wherein
the second transportation device is controlled by another control device different from a control device that controls the first transport device.

10. The control method according to claim 7, further comprising
predicting, as the travel status, a probability that the second transportation device is traveling in each transportation path.

11. The control method according to claim 7, further comprising
predicting, as the travel status, a current position of the second transportation device.

12. The control method according to claim 7, further comprising:
specifying, based on the travel status, a travel-prohibited path; and determining, based on information of the travel-prohibited path and the progress information, a travel plan for the first transportation device.

13. A control device comprising one or more memories storing instructions and one or more processors configured to execute the instructions to:
predict, based on progress information representing a progress of work involving transportation of goods, a travel status of a second transportation device being used for the work;
determine according to the travel status, a travel plan for a first transportation device being used for the work; and
control, based on the travel plan, the first transportation device.

14. The control device according to claim 13, wherein
the progress information is information acquired from a management device that integrally manages the work.

15. The control device according to claim 13, wherein
the second transportation device is controlled by another control device different from the control device.

16. The control device according to claim 13, wherein
the one or more processors are configured to execute the instructions to predict, as the travel status, a probability that the second transportation device is traveling in each transportation path.

17. The control device according to claim 13, wherein
the one or more processors are configured to execute the instructions to predict, as the travel status, a current position of the second transportation device.

18. The control device according to claim 13, wherein
the one or more processors are configured to execute the instructions to specify, based on the travel status, a travel-prohibited path, and determine, based on information of the travel-prohibited path and the progress information, a travel plan for the first transportation device.
